(19) United States
(12) Patent Application Publication
(10) Pub. No.: US 2024/0427080 A1
(43) Pub. Date: Dec. 26, 2024

(54) OPTICAL FIBER TAPE WITH WOVEN WEFT

(71) Applicant: CORNING RESEARCH & DEVELOPMENT CORPORATION, Corning, NY (US)

(72) Inventors: David Wesley Chiasson, Edmonton (CA); Bradford Aaron Knight, Charlotte, NC (US); William Welch McCollough, Lincolnton, NC (US); Alan Todd Parsons, Newton, NC (US); Rebecca Elizabeth Sistare, Hickory, NC (US)

(21) Appl. No.: 18/826,755

(22) Filed: Sep. 6, 2024

Related U.S. Application Data
(63) Continuation of application No. PCT/US2023/015334, filed on Mar. 16, 2023.
(60) Provisional application No. 63/325,256, filed on Mar. 30, 2022.

(51) Int. Cl. G02B 6/08; G02B 6/44

(52) U.S. Cl. CPC G02B 6/08; G02B 6/448

(57) ABSTRACT

Embodiments of the disclosure relate to an optical fiber tape. The optical fiber tape includes a plurality of optical elements positioned adjacently between a first outer optical element and a second outer optical element. The plurality of optical elements has an ordered arrangement between the first outer optical element and the second outer optical element. At least one weft is woven through the plurality of optical elements between the first outer optical element and the second outer optical element along a length of the optical fiber tape. The at least one weft is woven in a chain stitch or overlock stitch along the length of the optical fiber tape. The optical fiber tape is configured to transition between a planar configuration and a non-planar configuration while maintaining the ordered arrangement of the plurality of optical elements.

### CROSS-REFERENCE TO RELATED APPLICATIONS

This application is a continuation of International Application No. PCT/US2023/015334, filed Mar. 16, 2023, which claims the benefit of priority of U.S. Provisional Application Ser. No. 63/325,256 filed on Mar. 30, 2022, the content of which is relied upon and incorporated herein by reference in its entirety.

### BACKGROUND

The disclosure relates generally to a group of optical fibers or a grouping of optical fibers and, in particular, to optical fibers/groupings having a weft woven between the optical fibers/fiber groupings. A single optical fiber cable may contain many optical fibers (indeed, hundreds of optical fibers), and during installation of a fiber optic cable network, managing the connections between the optical fibers can be difficult. Thus, various portions of the optical fiber cable, such as individual optical fibers, buffer tubes, or groups of ribbons, may be color coded for the purposes of identification when making such connections. Further, the optical fiber cable may contain optical fibers arranged in ribbons to allow for multiple optical fibers to be grouped and to be fusion spliced together in a single operation. Arranging optical fibers into ribbons may lead to larger cable designs than if the optical fibers were loosely contained within the optical fiber cable.

### SUMMARY

According to an aspect, embodiments of the disclosure relate to an optical fiber tape. The optical fiber tape includes a plurality of optical elements positioned adjacently between a first outer optical element and a second outer optical element. The plurality of optical elements has an ordered arrangement between the first outer optical element and the second outer optical element. At least one weft is woven through the plurality of optical elements between the first outer optical element and the second outer optical element along a length of the optical fiber tape. The at least one weft is woven in a chain stitch or overlock stitch along the length of the optical fiber tape. The optical fiber tape is configured to transition between a planar configuration and a non-planar configuration while maintaining the ordered arrangement of the plurality of optical elements.

According to another aspect, embodiments of the disclosure relate to an optical fiber cable. The optical fiber cable includes a cable jacket having an inner surface and an outer surface. The inner surface defines a central bore along a longitudinal axis of the optical fiber cable, and the outer surface defines the outermost surface of the optical fiber cable. At least one optical fiber tape is disposed within the central bore of the cable jacket in a non-planar configuration. Each of the at least one optical fiber tape includes a plurality of optical elements positioned adjacently between a first outer optical element and a second outer optical element. At least one weft is woven through the plurality of optical elements between the first outer optical element and the second outer optical element along a length of the optical fiber tape. The at least one weft is woven in a chain stitch or overlock stitch along the length of the optical fiber tape, and the optical fiber tape is configured to transition between the non-planar configuration and a planar configuration.

According to a further aspect, embodiments of the disclosure relate to a method of manufacturing an optical fiber tape. In the method, a plurality of optical elements is arranged adjacently in a planar configuration between a first outer optical element and a second outer optical element. A first set of the plurality of optical elements is alternatingly separated from a second set of the plurality of optical elements. A weft is chain stitched or overlock stitched between the first set of the plurality of optical elements and the second set of the plurality of optical elements while alternatingly separating the first and the second sets of the plurality of optical elements.

Additional features and advantages will be set forth in the detailed description that follows, and, in part, will be readily apparent to those skilled in the art from the description or recognized by practicing the embodiments as described in the written description and claims hereof, as well as the appended drawings.

It is to be understood that both the foregoing general description and the following detailed description are merely exemplary, and are intended to provide an overview or framework to understand the nature and character of the claims.

### BRIEF DESCRIPTION OF THE DRAWINGS

The accompanying drawings are included to provide a further understanding and are incorporated in and constitute a part of this specification. The drawings illustrate one or more embodiment(s), and together with the description serve to explain principles and the operation of the various embodiments.

FIG. 1 depicts a perspective view of an optical fiber tape having a weft woven between optical elements, according to an exemplary embodiment;

FIGS. 2A-2C depict weave patterns for the weft between the optical elements of the optical fiber tape, according to exemplary embodiments;

FIGS. 3A and 3B depict a first process of weaving a weft between optical elements, according to an exemplary embodiment;

FIGS. 4A and 4B depict a second process of weaving a weft between optical elements, according to an exemplary embodiment;

FIG. 5 depicts a perspective view of an optical fiber tape having a chain stitched weft woven between optical elements, according to an exemplary embodiment; and

FIGS. 6A and 6B depict a process of chain stitching a weft between optical elements, according to an exemplary embodiment.

### DETAILED DESCRIPTION

Referring generally to the figures, various embodiments of an optical fiber tape having a weft woven between optical elements and related methods for forming same are provided. As will be discussed more fully below, weaving a weft between the optical elements provides an optical fiber tape form that is reconfigurable between planar and non-planar configurations while also reducing the amount of material needed to form the optical fiber grouping and providing enhanced ease of access to the individual optical elements of the grouping. In a particular embodiment described herein, the weft is stitched in a chain stitch or overlock stitch between optical elements of the tape. Advantageously, the weft maintains the order of the optical elements within the tape when transitioning between the planar and non-planar configurations, and the weft or wefts of an optical fiber tape can be color-coded to provide identification among multiple optical fiber tapes within an optical fiber cable. Exemplary embodiments of the optical fiber tape having a woven weft will be described in greater detail below and in relation to the figures provided herewith, and these exemplary embodiments are provided by way of illustration, and not by way of limitation.

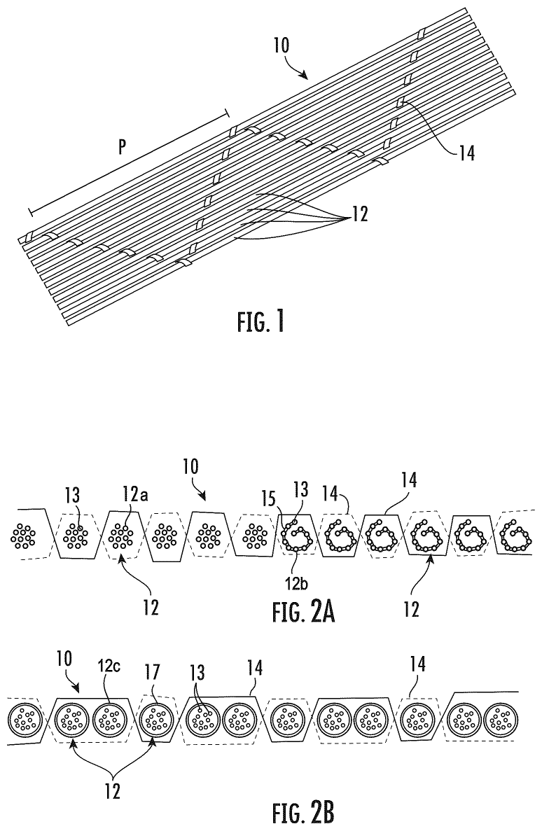

FIG. 1 depicts an embodiment of an optical fiber tape 10 having a plurality of optical elements 12 bound together with one or more wefts 14. As used herein, the “optical elements” are optical fibers and/or components of an optical fiber cable that contain optical fibers. For example, optical elements may be individual bare or color-coated optical fibers, bunched groups of individual optical fibers, rollable or collapsible ribbons (e.g., ribbons with optical fibers intermittently bonded along the length of the ribbon), buffer tubes with optical fibers in a loose tube or ribbon configuration, tight-buffered optical fibers, or a mixture thereof. Further, the optical elements may be a nested arrangement of optical fiber tapes 10, such as a plurality of tapes of individual optical fibers being the optical element 12 of a larger optical fiber tape 10.

Further, as used herein, “weft” is meant to encompass a variety of narrow, flexible strips of material, including a strip of a single continuous material or a strip of multiple continuous or discontinuous materials, having the properties described below. For example, in one or more embodiments, the weft 14 may be any of various tapes, ribbons, strings, rovings, cords, threads, fibers, filaments, yarns, and twines, among others. Further, in one or more embodiments, the weft 14 is made from any of a variety of natural or synthetic materials. In one or more embodiments, the weft 14 is comprised of straight or twisted filaments of a polymer materials such as polyester, nylon or natural materials such as cotton, hemp, silk, etc. Other options for the weft might include an in-process created single filament that is extruded and then immediately woven into the structure. In one or more embodiments of the optical fiber tape 10, the optical fiber tape 10 includes from two to forty-eight optical elements 12, in particular from twelve to thirty-six optical elements 12.

In one or more embodiments, the optical elements 12 of the optical fiber tape 10 are only held together by the weft 14. That is, in contrast to conventional optical fiber ribbons which only include optical fibers continuously bonded along their length, the optical elements 12 of the optical fiber tape 10 can be larger optical fiber groupings that are not held together along their length by any continuous or discontinuous binder matrix. However, in one or more embodiments, a subset of optical elements 12 of the optical fiber tape 10 may be joined by a binder matrix. For example, the optical fiber tape 10 may contain twelve optical elements 12 arranged in subunits in which, e.g., two, three, or four optical elements 12 (such as optical fibers) may be continuously or intermittently bonded along their length. In such an embodiment, the weft 14 would then hold the subunits of optical elements 12 together along the length of the optical fiber tape 10. Additionally, the optical fiber tape 10 may include optical elements 12 (such as buffer tubes) that contain continuously bonded optical fibers (such as optical fiber ribbons)

Advantageously, using a weft 14 to hold the optical elements 12 or subunits of optical elements 12 together decreases the amount of material used to form the optical fiber tapes 10. Further, the weft 14 increases the flexibility of the optical fiber tape 10 such that the optical fiber tape 10 can be rolled, folded, or bent into a more compact space. That is, conventional optical fiber ribbons, especially those with a continuous binder matrix along their length, are rigidly held in a planar configuration. In contrast, the weft 14 is not adhered to the optical elements 12 within and thus the presently disclosed optical fiber tapes 10 can be collapsed (e.g., rolled, folded, bunched, or bent) from a planar configuration into a non-planar configuration and the optical fiber tape 10 will maintain that configuration. The optical fiber tape 10 can then be subsequently expanded (e.g., unrolled, unfolded, unbunched, or unbent) from the non-planar configuration back into the planar configuration. Advantageously, the order of the optical elements 12 is maintained when transitioning between configurations. Such reconfigurability allows for the optical fiber tape 10 to be processed and stored in a planar configuration when the accumulated length is placed on a reel, then collapsed to form a densely packed configuration within an optical fiber cable thus increasing the fiber count within a given cable cross-section, and converted back to a planar configuration for efficient identification and component extraction.

FIG. 1 depicts a first embodiment of a weft 14 woven into an optical fiber tape 10. Using weaving terminology, “warp” is the longitudinal portion of the weave and, in this context, refers to the optical elements 12, and “weft,” i.e., weft 14, is the transverse portion of the weave. As shown in FIG. 1, the weft 14 moves in a zigzag pattern across the optical elements 12. In contrast to a traditional weave in which the warp is processed rather slowly, here, the optical elements 12 will be moving along a processing line at several meters per minute (e.g., up to five hundred meters per minute) while the weft 14 is woven into the optical elements 12. Thus, as the weft 14 passes through the moving optical elements 12, the weft 14 will traverse the warp at an angle less than 90 degrees rather than perpendicular to it such as in the creation of a textile. In one or more embodiments, the pitch P between weft 14 (peak to peak or valley to valley) is up to 500 mm, in particular in a range from 5 mm to 100 mm.

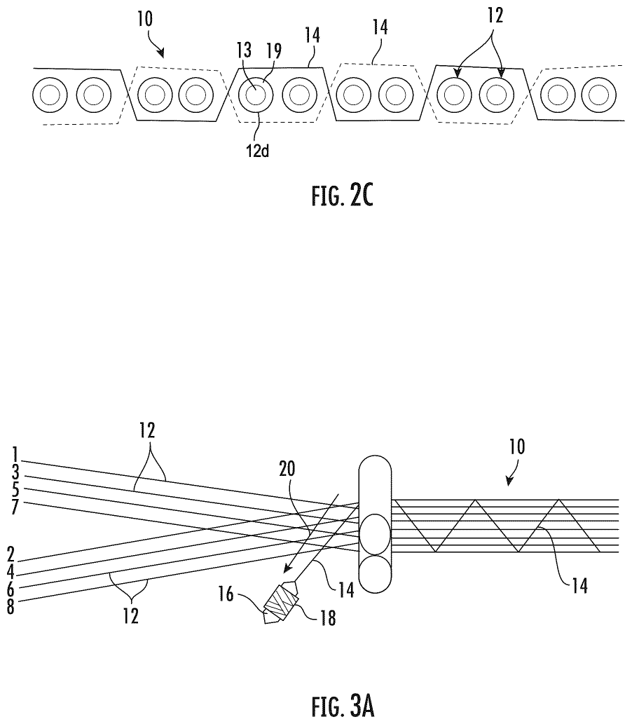

In one or more embodiments, such as the embodiment shown in FIGS. 1 and 2A, the through pass (shown in solid line in FIG. 2A) of the weft 14 passes over every other warp optical element 12. On the return pass (shown in dashed line in FIG. 2A), the weft 14 passes under the optical elements 12 over which the weft 14 passed on the through pass. As shown in FIG. 2A, the optical elements 12 of the optical fiber tape 10 include bunched groupings 12a of individual optical fibers 13 and rollable ribbons 12b including optical fibers 13 connected by intermittent bonds 15.

In one or more embodiments, the through pass of the weft 14 passes over one warp optical element 12 and then under two to four warp optical elements 12, and the return pass is the opposite (i.e., over two to four warp optical elements 12 and under one warp optical elements 12). In a particular embodiment depicted in FIG. 2B, the through pass (solid line) of the weft 14 passes over one warp optical element 12, under two warp optical elements 12, over one warp optical element 12, and so on. On the return pass (dashed line), the weave pattern would be reversed such that the weft 14 passes over two warp optical elements 12, under one warp optical element 12, over two warp optical elements 12, and so on. Further, in the embodiment shown in FIG. 2B, the particular optical elements 12c are buffer tubes 17 containing a plurality of optical fibers 13 in a loose tube configuration. In one or more other embodiments, the buffer tubes 17 may include optical fibers 13 in a ribbon configuration, including in a rollable or collapsible ribbon configuration.

In one or more embodiments, the weft 14 on the through pass passes over two to four warp optical elements 12, then under an equal number of warp optical elements 12, and so on. On the return pass, the weave pattern is the opposite. In the particular embodiment depicted in FIG. 2C, the through pass (solid line) of the weft 14 passes over two warp optical elements 12, under two warp optical elements 12, over two warp optical elements 12, and so on, and on the return pass (dashed line), the weft 14 passes under two warp optical elements 12, over two warp optical elements 12, under two warp optical elements 12, and so on. In the embodiment shown in FIG. 2C, the optical elements 12 are tight-buffered optical fibers 12d having optical fibers 13 surrounded by a tight buffer tube 19.

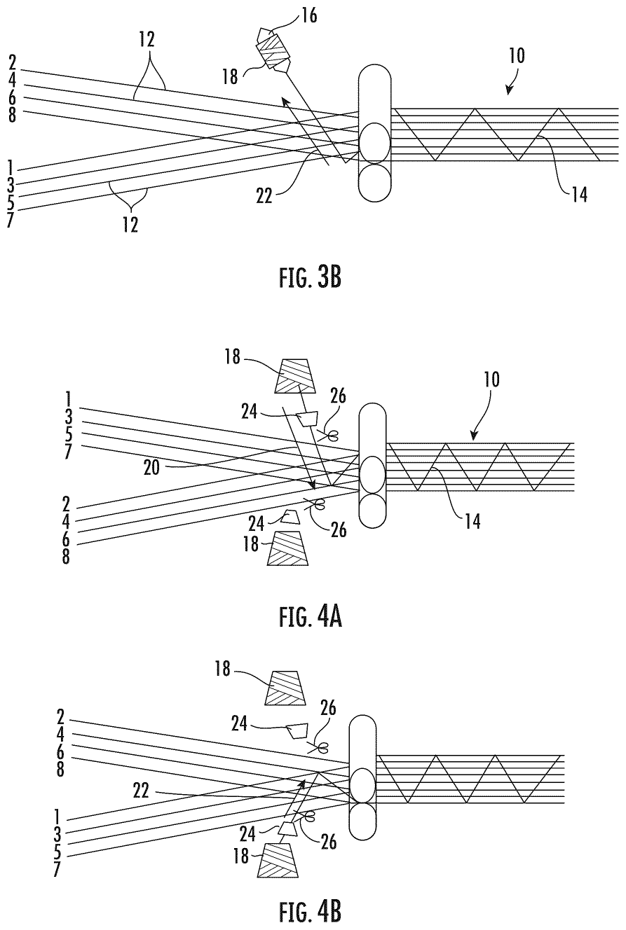

In one or more embodiments, the weft 14 is woven through the warp optical elements 12 by passing a shuttle 16 as shown in FIG. 3A back and forth across a run of warp optical elements 12. In the embodiment shown in FIG. 3A, there are eight warp optical elements 12, and the weft 14 is woven over and under alternating warp optical elements 12. In order to weave the weft 14 through the warp optical elements 12, half of the warp optical elements 12 (labeled 1, 3, 5, 7) are raised, and half the warp optical elements 12 (labeled 2, 4, 6, 8) are lowered. The shuttle 16 contains a spool 18 of the weft 14, and the shuttle 16 is passed in a first direction 20 between the raised and lowered warp optical elements 12. The raised warp optical elements 12 (labeled 1, 3, 5, 7) are then lowered, and the lowered warp optical elements 12 (labeled 2, 4, 6, 8) are then raised. The shuttle 16 is then passed back through the warp optical elements 12 in a second direction 22. By alternating raised and lowered warp optical elements 12 while the shuttle 16 is passed back-and-forth through the warp optical elements 12, the weft 14 weaves the warp optical elements 12 together into the optical fiber tape 10.

In one or more other embodiments, the weft 14 may be woven into the optical fiber tape 10 using other weaving processes, such as shown in FIGS. 4A and 4B. In an embodiment, the weft 14 is woven into the optical fiber tape 10 using an air or water jet. In such embodiments, the weft 14 is not carried on a shuttle, and instead, as shown in FIGS. 4A and 4B, the weft 14 is jetted through a nozzle 24 across the warp optical elements 12, which are alternatingly raised and lowered. In particular embodiments, two weft strands 14 may be used with spools 18 positioned on opposite sides of the warp optical elements 12. In this way, each weft 14 is jetted through each nozzle 24 across the warp optical elements 12 in a single direction. Because the weft 14 is not returned and is only jetted in one direction, the weft strand is cut using shears 26. For this weft process and the resultant configuration, friction between the fibers and weft or some adhesion between the weft and the optical elements is necessary for maintaining the integrity of the tape structure.

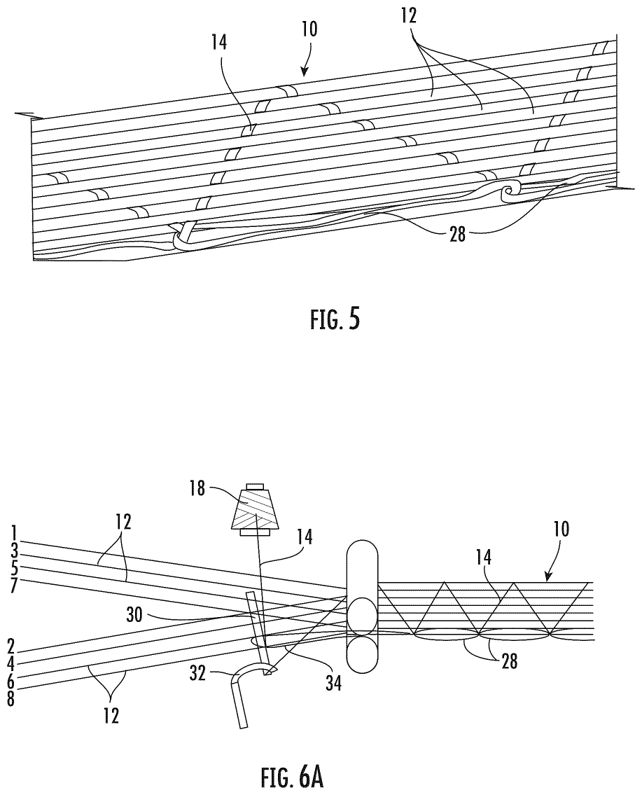

FIG. 5 depicts another embodiment of the weft 14 woven into an optical fiber tape 10. In the embodiment shown in FIG. 5, the weft 14 is woven into the optical fiber tape 10 using a chain stitch 28. The chain stitch 28 is a continuous weft 14 in which the weft 14 is looped back on itself once on a side of the optical fiber tape 10.

In one or more embodiments, the through pass and the return pass of the weft 14 pass over and under the same warp optical elements 12. For example, the weft 14 passes over every other warp optical element 12 on both the through pass and the return pass. As shown in FIG. 5, the through pass and return pass create a V in which the weft 14 pass over and under the same warp optical elements 12. In one or more embodiments, the through pass and the return pass of the weft 14 pass over one warp optical element 12 and then under two to four warp optical elements 12. In one or more embodiments, the weft 14 on the through pass and the return pass passes over two to four warp optical elements 12, then under an equal number of warp optical elements 12, and so on.

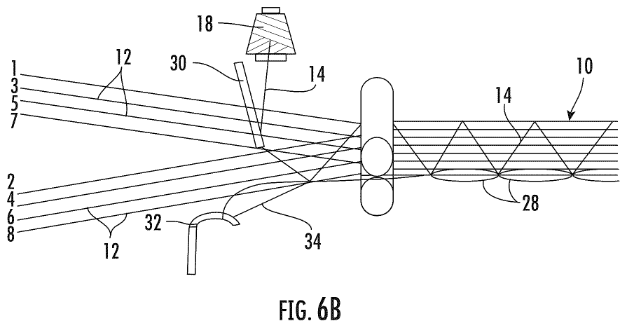

FIGS. 6A and 6B depict an example embodiment of a process for chain stitching the weft 14 through the optical elements 12 to form the optical fiber tape 10. As shown in FIG. 6A, there are eight warp optical elements 12, and the weft 14 is woven over and under alternating warp optical elements 12 and chain stitched on one side of the optical fiber tape 10. In order to weave the weft 14 through the warp optical elements 12, half of the warp optical elements 12 (labeled 1, 3, 5, 7) are raised, and half the warp optical elements 12 (labeled 2, 4, 6, 8) are lowered. A pin 30 carrying the weft 14 from the spool 18 is inserted across the warp optical elements 12 from a first outer optical element (element 1) to a second outer optical element (element 8). A rotating or reciprocating hook 32 catches the weft 14 to form a loop 34, which creates the chain stitch 28. As can be seen in FIG. 6A, the weft 14 is inserted into the loop 34, and as the warp optical elements 12 continue to move rightward in FIG. 6A, the loop 34 is formed in the leftward direction as shown in FIG. 6B while the pin 30 is withdrawn across the warp optical elements 12. Thereafter, the warp optical elements 12 switch between the raised and lowered positions, the hook 32 reciprocates or rotates to release the loop 34, and the weft 14 is again inserted, hooked, and withdrawn to continue chain stitching the warp optical elements 12 along the length of the optical fiber tape 10. In one or more other embodiments, multiple wefts 14 may be used during the chain stitching process to create an overlock stitch. For example, the reciprocating hook 32 can be configured to carry a weft that forms interlocking loops with the pin 30, and additional wefts can be incorporated by including additional hooks 32 and pins 30 in which the reciprocating motion of each hook and pin creates interlocking loops of the wefts.

Chain stitching the optical elements 12 in this way provides the advantage of case of access to the optical elements 12 in the optical fiber tape 10. In particular, the weft 14 can be cut at any point along the length of the optical fiber tape 10, and by pulling the weft 14, the chain stitching or overlock stitching can be undone over as much of the optical fiber tape 10 as needed to access the optical elements 12. The chain stitching preceding and after that access point will remain in place, binding the optical elements 12 together along the optical fiber tape 10.

In one or more embodiments, the weft 14 comprises a weight of from 100 to 550 denier, in particular from 200 to 450 denier. Further, in order to adequately bind the optical elements 12 of the optical fiber tape 10, the weft 14 in one or more embodiments comprises a coefficient of friction with respect to the optical elements 12 of from 0.1 to 0.5, in particular from 0.25 to 0.4 (as measured according to ASTM D3108/D3108M-13 (2020)). In still one or more other embodiments, the weft 14 is impregnated or coated with a water-blocking compound, such as super absorbent polymer, to provide protecting against water intrusion.

Further, in one or more embodiments, the optical fiber tapes 10 are incorporated into an optical fiber cable. In such embodiments, the optical fiber cable includes a cable jacket having an inner surface and an outer surface. The inner surface defines a central bore extending along the longitudinal axis of the optical fiber cable. The outer surface defines the outermost surface of the optical fiber cable. The optical fiber cable includes at least one optical fiber tape 10, and in embodiments, the optical fiber cable includes up to 1152 optical fiber tapes 10.

In one or more embodiments, the optical fiber tapes 10 are contained within the optical fiber cable in a non-planar configuration. That is, the optical fiber tape 10 is collapsed (folded, bent, bunched, or rolled) into a smaller width than the planar configuration. In this way, the optical elements within the tape can occupy much of the interstitial space within the cable and thus the density of optical fiber elements within the optical fiber cable can be increased. Further, in one or more embodiments, the weft 14 of each optical fiber tape 10 is a particular color to identify each optical fiber tape 10 from among a plurality of optical fiber tapes 10 within the optical fiber cable. A variety of different color-coding methods are known in the art for use with buffer tubes and individual optical fibers, and according to the present disclosure, such color coding methods can be applied to the wefts 14 of the optical fiber tapes 10 within the optical fiber cable. Further, in such embodiments, multiple wefts 14 (e.g., in an interlocking chain stitch or overlock stitch) may be used for each optical fiber tape 10 to provide identification. Thus, in such embodiments, the woven optical fiber tapes 10 provide not only advantages in terms of material savings, compact storage of optical elements 12, and ease of access but also in terms of organization of the optical elements 12 within the optical fiber cable.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that any particular order be inferred. In addition, as used herein, the article “a” is intended to include one or more than one component or element, and is not intended to be construed as meaning only one.

It will be apparent to those skilled in the art that various modifications and variations can be made without departing from the spirit or scope of the disclosed embodiments. Since modifications, combinations, sub-combinations and variations of the disclosed embodiments incorporating the spirit and substance of the embodiments may occur to persons skilled in the art, the disclosed embodiments should be construed to include everything within the scope of the appended claims and their equivalents.

What is claimed is:

1. An optical fiber tape, comprising:
a plurality of optical elements positioned adjacently between a first outer optical element and a second outer optical element, the plurality of optical elements comprising an ordered arrangement between the first outer optical element and the second outer optical element; and
at least one weft woven through the plurality of optical elements between the first outer optical element and the second outer optical element along a length of the optical fiber tape;
wherein the at least one weft is woven in a chain stitch or overlock stitch along the length of the optical fiber tape; and
wherein the optical fiber tape is configured to transition between a planar configuration and a non-planar configuration while maintaining the ordered arrangement of the plurality of optical elements.

2. The optical fiber tape of claim 1, wherein the at least one weft comprises a weight of 100 to 550 denier.

3. The optical fiber tape of claim 1, wherein the at least one weft comprises a tape, a ribbon, a string, a roving, a cord, a thread, a fiber, a filament, a yarn, or a twine.

4. The optical fiber tape of claim 1, wherein the plurality of optical elements comprises at least one of individual optical fibers, bunched groups of optical fibers, rollable ribbons, tight-buffered optical fibers, or buffer tubes comprising a plurality of optical fibers.

5. The optical fiber tape of claim 1, wherein the at least one weft is woven over every other optical element of the plurality of optical elements.

6. The optical fiber tape of claim 1, wherein the at least one weft is woven over every other two to four optical elements of the plurality of optical elements.

7. The optical fiber tape of claim 1, wherein the at least one weft comprises polyester, nylon, cotton, hemp, or silk.

8. The optical fiber tape of claim 1, wherein a coefficient of friction between the plurality of optical elements and the at least one weft is from 0.1 to 0.5.

9. An optical fiber cable, comprising:
a cable jacket comprising an inner surface and an outer surface, the inner surface defining a central bore along a longitudinal axis of the optical fiber cable and the outer surface defining an outermost surface of the optical fiber cable;
at least one optical fiber tape disposed within the central bore of the cable jacket in a non-planar configuration;
wherein each of the at least one optical fiber tape comprises:
a plurality of optical elements positioned adjacently between a first outer optical element and a second outer optical element; and
at least one weft woven through the plurality of optical elements between the first outer optical element and the second outer optical element along a length of the optical fiber tape;
wherein the at least one weft is woven in a chain stitch or overlock stitch along the length of the optical fiber tape; and
wherein the optical fiber tape is configured to transition between the non-planar configuration and a planar configuration.

10. The optical fiber cable of claim 9, wherein the plurality of optical elements of each of the at least one optical fiber tape comprises an ordered arrangement between the first outer optical element and the second outer optical element and wherein each of the at least one optical fiber tape is configured to maintain the ordered arrangement of the plurality of optical elements when transitioning between the planar configuration and the non-planar configuration.

11. The optical fiber cable of claim 9, wherein the at least one weft of each of the at least one optical fiber tape comprises a weight of 100 to 550 denier.

12. The optical fiber cable of claim 9, wherein a coefficient of friction between the plurality of optical elements and the weft of each of the at least one optical fiber tape is from 0.1 to 0.5.

13. The optical fiber cable of claim 9, wherein the weft of each of the at least one optical fiber tape comprises polyester, nylon, cotton, hemp, or silk.

14. A method of manufacturing an optical fiber tape, comprising:
arranging a plurality of optical elements adjacently in a planar configuration between a first outer optical element and a second outer optical element;
alternatingly separating a first set of the plurality of optical elements from a second set of the plurality of optical elements; and
chain stitching or overlock stitching a weft between the first set of the plurality of optical elements and the second set of the plurality of optical elements while alternatingly separating the first set of the plurality of optical elements and the second set of the plurality of optical elements.

15. The method of claim 14, wherein alternatingly separating and chain stitching or overlock stitching comprises:
separating the first set of the plurality of optical elements from the second set of the plurality of optical elements by raising the first set of the plurality of optical elements relative to the second set of the plurality of optical elements;
inserting the weft across the plurality of optical elements from the first outer optical element to the second outer optical element and between the first set of the plurality of optical elements and the second set of the plurality of optical elements;
hooking the weft past the second outer optical element to form a loop;
withdrawing the weft across the plurality of optical elements;
separating the first set of the plurality of optical elements from the second set of the plurality of optical elements by raising the second set of the plurality of optical elements relative to the first set of the plurality of optical elements;
inserting the weft across the plurality of optical elements from the first outer optical element to the second outer optical element and through the loop; and
repeating the hooking, withdrawing, and inserting along a length of the optical fiber tape.

16. The method of claim 14, wherein the weft comprises a weight of 100 to 550 denier.

17. The method of claim 14, wherein the weft comprises polyester, nylon, cotton, hemp, or silk.

18. The method of claim 14, wherein the first set of the plurality of optical elements comprises every other optical element from the first outer optical element to the second outer optical element.

19. The method of claim 14, wherein the first set of the plurality of optical elements comprises every outer two to four optical elements from the first outer optical element to the second outer optical element.

20. The method of claim 14, wherein the weft comprises a tape, a ribbon, a string, a roving, a cord, a thread, a fiber, a filament, a yarn, or a twine.
